(19) United States
(12) Patent Application Publication
(10) Pub. No.: US 2024/0227399 A1
(43) Pub. Date: Jul. 11, 2024

(54) HIGH RELIABILITY SHEATHED TRANSPORT PATH FOR AEROSOL JET DEVICES

(71) Applicant: Optomec, Inc., Albuquerque, NM (US)

(72) Inventors: John S. Wright, Edina, MN (US); Chad Michael Conroy, Minneapolis, MN (US); Michael J. Renn, New Richmond, WI (US); Kurt K. Christenson, Minnetonka, MN (US); John David Hamre, Plymouth, MN (US)

(73) Assignee: Optomec, Inc., Albuquerque, NM (US)

(21) Appl. No.: 18/288,534

(22) PCT Filed: Apr. 29, 2022
(86) PCT No.: PCT/US2022/027078

§ 371 Date: Oct. 26, 2023

Related U.S. Application Data
(60) Provisional application No. 63/181,736, filed on Apr. 29, 2021.

(51) Int. Cl. B41J 2/165; B05B 7/04; B05B 7/12; B05B 7/14; B05B 15/58; B41J 2/14

(52) U.S. Cl. CPC B41J 2/165; B05B 7/0491; B05B 7/12; B05B 7/1486; B05B 15/58; B41J 2/14; B41J 2002/14475; B41J 2002/16502

(57) ABSTRACT

An apparatus and method for depositing an aerosol that has an ultrafast pneumatic, shutter. The flow of aerosol through the entire deposition flow path is surrounded by at least one sheath gas, thereby greatly increasing reliability. The distance between the aerosol switching chamber and a reverse gas flow chamber input is minimized to reduce switching time. The distance from the switching chamber to the nozzle exit is also minimized to reduce switching time. The gas flows in the system are configured to maintain a substantially constant pressure in the system, and consequently substantially constant flow rates through the deposition nozzle and exhaust nozzle, to minimize on/off switching times. This enables the system to have a switching time of less than 10 ms.

### CROSS-REFERENCE TO RELATED APPLICATIONS

This application claims priority to and the benefit of the filing of U.S. Provisional Patent Application No. 63/181,736, entitled “HIGH RELIABILITY SHEATHED TRANSPORT PATH FOR AEROSOL JET DEVICES”, filed on Apr. 29, 2021, the entirety of which is incorporated herein by reference.

### BACKGROUND OF THE INVENTION

### Field of the Invention (Technical Field)

The present invention is related to apparatuses and methods for propagating an aerosol stream and pneumatic shuttering of an aerosol stream. The aerosol stream can be a droplet stream, a solid particle stream, or a stream comprising droplets and solid particles or droplets that contain solid particles.

### BACKGROUND ART

Note that the following discussion may refer to a number of publications and references. Discussion of such publications herein is given for more complete background of the scientific principles and is not to be construed as an admission that such publications are prior art for patentability determination purposes.

Some aerosol jet deposition systems add a sheath of gas to the aerosol flow just prior to the deposition nozzle to focus the aerosol beam, accelerate the flow and to protect the inside of the nozzle. The upstream interior portion of the aerosol delivery path from the aerosol generation source prior to the sheath addition is in contact with the aerosol and is susceptible to failures caused by material build up. This portion of the mist path may include mist tubes or channels, junctions, pneumatic shutter components, or other portions of the mist path. Surfaces exposed to the aerosol risk potential material build up which can alter flow geometry and degrade system performance. Accumulation of deposition material in the transport path can result in print material output variation and print geometry errors. If enough material accumulates, a catastrophic failure occurs resulting in complete blockage of the aerosol flow. Failures resulting from material build up tend to be statistical in nature, are strongly affected by print material rheology, and are difficult to predict, making the design of material agnostic systems with run times greater than 4-8 hours difficult to accomplish. Thus, there is a need for a high reliability aerosol delivery path that can run for more than 24 hours capable of supporting typical transport path functionality such as, but not limited to, internal pneumatic shuttering.

### SUMMARY OF THE INVENTION (DISCLOSURE OF THE INVENTION)

An embodiment of the present invention is a method for controlling deposition of an aerosol, the method comprising: supplying an aerosol to a transport tube in a deposition apparatus; surrounding the exterior of the transport tube with a transport sheath gas; surrounding the aerosol with the transport sheath gas before the aerosol enters the transport tube; transporting the aerosol and surrounding transport sheath gas to a switching chamber of the deposition apparatus; exhausting a boost gas and an exhaust sheath gas from the deposition apparatus: surrounding both the aerosol and the transport sheath gas with a deposition sheath flow to form a combined flow; passing the combined flow through a deposition nozzle; switching a flow path of the boost gas so it is added to the deposition sheath flow instead of being exhausted from the deposition apparatus, thereby stopping a flow of the aerosol into the deposition nozzle; and exhausting the aerosol from the deposition apparatus. The pressure in the switching chamber preferably remains approximately constant while performing the method. The gas flow rate through the deposition nozzle is preferably approximately constant while performing the method. The aerosol is preferably surrounded by at least one sheath gas until the step of exhausting the aerosol from the deposition apparatus, thereby preventing the aerosol from accumulating on surfaces of an aerosol transport path through the deposition apparatus. The step of exhausting the boost gas and the exhaust sheath gas from the deposition apparatus preferably comprises passing the boost gas and the exhaust sheath gas through an exhaust nozzle. The step of exhausting the aerosol from the deposition apparatus preferably comprises surrounding the aerosol with the exhaust sheath gas before the aerosol passes through the exhaust nozzle. The flow rate through the exhaust nozzle is preferably approximately constant while performing the method.

The time required to switch the aerosol from flowing toward the deposition nozzle to flowing toward the exhaust of the deposition apparatus is preferably less than approximately 1 ms. The time required for the flow of aerosol to stop exiting the deposition nozzle after the switching step is preferably less than approximately 10 ms. The method of claim 1 preferably further comprises switching back a flow path of the boost gas so it is exhausted from the deposition apparatus instead of being added to the deposition sheath flow, thereby starting a flow of the aerosol toward the deposition nozzle; and passing the combined flow through the deposition nozzle. The time required to switch the aerosol from flowing toward an exhaust of the deposition apparatus to flowing toward the deposition nozzle is preferably less than approximately 1 ms. The time required for a predetermined flow of aerosol to exit the deposition nozzle after the switching back step is preferably less than approximately 10 ms. The method optionally further comprises dividing the transport sheath gas into an exhaust portion and a deposition portion after the transporting step so that the combined flow comprises the aerosol surrounded by the deposition portion, both being surrounded by the deposition sheath flow. In this case the step of exhausting a boost gas and an exhaust sheath gas from the deposition apparatus preferably comprises surrounding the exhaust portion with the boost gas and exhaust sheath gas and exhausting the exhaust portion, the boost gas, and the exhaust sheath gas from the deposition apparatus.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings:

FIG. 1 is a schematic of an embodiment of aerosol jet print engine aerosol transport path showing flows and aerosol distribution.

FIG. 2 is a schematic of an embodiment of aerosol jet print engine aerosol transport path incorporating an internal pneumatic shutter showing flows and aerosol distribution in the deposition configuration.

FIG. 3 is a schematic of the flows and aerosol distribution of the system of FIG. 2 in at the initiation of the diversion configuration.

FIG. 4 is a schematic of the flows and aerosol distribution of the system of FIG. 2 in the diversion configuration.

FIG. 5 is a schematic of the flows and aerosol distribution of the system of FIG. 2 at the initiation of the deposition configuration.

FIG. 6 is a schematic of the flows and aerosol distribution of the system of FIG. 2 in the diversion configuration with a mass flow controller-based exhaust configuration.

FIG. 7 is a geometric representation indicating the flow distribution and some dimensions of the switching gallery of the present invention in the diversion configuration.

### DETAILED DESCRIPTION OF EMBODIMENTS OF THE INVENTION

Embodiments of the present invention are apparatuses and methods for propagation and diversion of an aerosol stream for use in, but not limited to, aerosol jet printing of material onto planar and three-dimensional surfaces. As used throughout the specification and claims, the term “aerosol” means liquid droplets (which may optionally contain solid material in suspension), fine solid particles, or mixtures thereof, which are transported by a carrier gas.

In one or more embodiments of the present invention an aerosol delivery path is incorporated into an apparatus which transports material from an aerosol source, such as an ultrasonic or pneumatic atomizer, to a deposition nozzle. Prior to entering the deposition nozzle, a concentric sheath of gas is applied to surround the aerosol stream. As the combined stream flows through the nozzle, focusing of the aerosol occurs, resulting in deposition of printed features as small as 10 μm in width. In one or more embodiments of the present invention, an internal pneumatic shutter for diverting the material flow is used in coordination with movement of the deposition nozzle relative to the print substrate resulting in deposition of desired print features. Example internal pneumatic shuttering systems are described in more detail in commonly-owned U.S. Pat. No. 10,632,746, incorporated herein by reference.

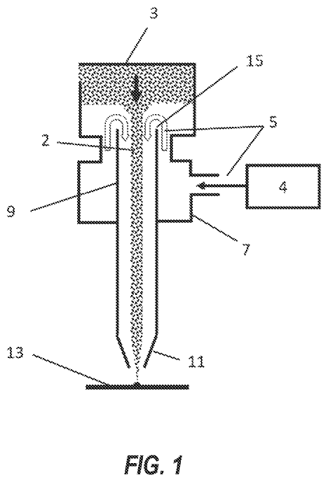

An aerosol transport path comprising an embodiment of a sheathed aerosol transport path for a print engine of the present invention is shown in FIG. 1. An aerosol source, such as a pneumatic atomizer, generates aerosol 2 and delivers it to mist chamber 3. Mass flow controller 4, connected to a compressed gas supply (not shown), supplies master sheath gas 5, preferably through a mass flow controller, which enters master sheath gas plenum 7 and is circumferentially injected into the mist chamber 3 around the outside diameter of mist tube 9. Flows in the transport path are preferably low enough to insure laminar flow. Master sheath gas 5 remains in contact with mist tube 9 and flows over top surface 15 of mist tube 9, surrounding aerosol 2 and separating it from all surfaces of mist tube 9. Aerosol 2 and master sheath gas 5 form a preferably annular, axisymmetric, layered flow that travels down mist tube 9 to deposition nozzle 11, where it is constricted and/or focused, causing it to accelerate. The high velocity aerosol exits deposition nozzle 11 and impacts on print surface 13, resulting in deposition of desired features. All surfaces of mist tube 9 are covered with a flow of master sheath gas 5, and at no point are they in contact with aerosol 2, thus preventing any opportunity for material buildup.

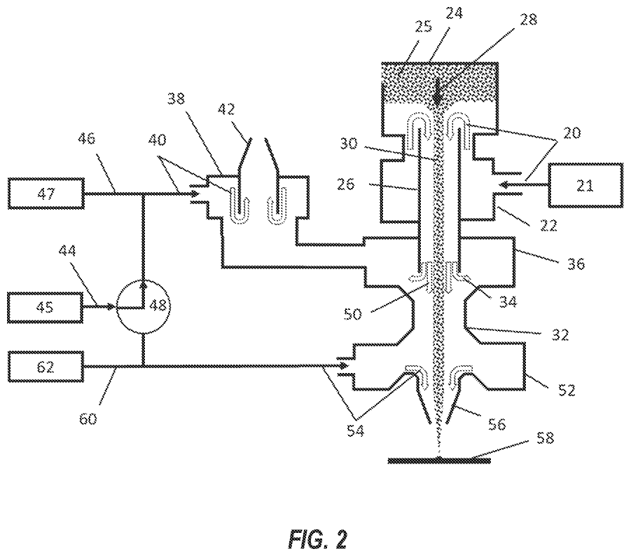

In an alternative embodiment of the current invention, an internal pneumatic shutter is incorporated in the mist delivery path and is shown in FIG. 2. Similar to the system of FIG. 1, an aerosol source generates aerosol 25 and delivers it to mist chamber 24. Master sheath gas flow 20, preferably provided by a sheath mass flow controller 21 connected to a compressed gas supply, enters master sheath gas plenum 22 and is circumferentially injected into the mist chamber 24 around the outside diameter of mist tube 26 and propagates down the inside of mist tube 26 in the direction of the arrow 28 surrounding aerosol flow 30. Aerosol flow 30 and master sheath gas flow 20 preferably remain constant during diverting, printing, and switching (described below). Aerosol flow 30 and master sheath gas flow 20 exit mist tube 26 and propagate into switching gallery 32. Exhaust sheath flow portion 34 of the master sheath gas flow enters exhaust plenum 36 and propagates to exhaust sheath plenum 38, where it is preferably surrounded with exhaust sheath flow 40 and expelled out exhaust nozzle 42. Exhaust sheath flow 40 is a combination of the exhaust fill flow 46, preferably provided by an exhaust fill mass flow controller 47 connected to a compressed gas supply, and boost flow 44, preferably provided by a boost mass flow controller 45 connected to a compressed gas supply, which is directed into exhaust sheath flow 40 through valve 48. Aerosol flow 30 and the remaining sheath flow portion 50 of the master sheath gas flow propagate through switching gallery 32 and past sheath-boost plenum 52, where sheath-boost flow 54 is circumferentially added. Aerosol flow 30, remaining sheath flow portion 50, and sheath-boost flow 54 enter deposition nozzle 56. Sheath-boost flow 54 and remaining sheath flow portion 50 prevent aerosol flow 30 from contacting the walls of the mist path and assist in accelerating and focusing aerosol flow 30 into a focused beam as it exits deposition nozzle 56 to insure precise and controlled impaction on print surface 58. Deposition sheath flow 60, which in this configuration is the same as sheath-boost flow 54, is preferably provided by deposition sheath mass flow controller 62 connected to a compressed gas supply. Switching gallery 32 is preferably directly connected to sheath-boost plenum 52, without requiring the use of a mist tube to connect the flows in each chamber.

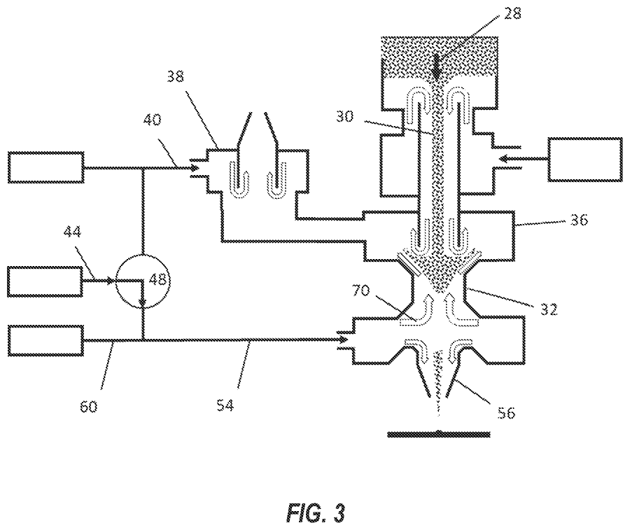

Initiation of the process for diverting the aerosol flow, shown in FIG. 3, is caused by actuating valve 48 so that boost flow 44 is removed from the exhaust sheath flow 40 and is added to deposition sheath flow 60 to augment sheath-boost flow 54. Since the flow out of deposition nozzle 56 is preferably constant, reverse boost flow 70 is forced to flow away from deposition nozzle 56, opposing the flow of the aerosol flow 30 and reversing its direction. Nearly simultaneously, the absence of boost flow 44 into exhaust sheath plenum 38 causes the flow out of exhaust plenum 36 to be increased by the amount of boost flow 44, aiding in the reversal of the flow fields associated with the reversing aerosol flow 30. Since the resistances of the nozzles remain constant and the total flow into mist delivery system remains substantially constant, the pressure in the switching gallery 32 remains substantially constant. Constant pressure operation ensures constant aerosol output at deposition nozzle 56 and avoids delays associated with waiting for the system to reach pressure equilibrium. Constant pressure operation enables redirection of the aerosol flow in the switching gallery 32 in less than about 1 ms. The aerosol remaining in deposition nozzle 56 is expelled less than about 10 ms after boost flow 44 is switched.

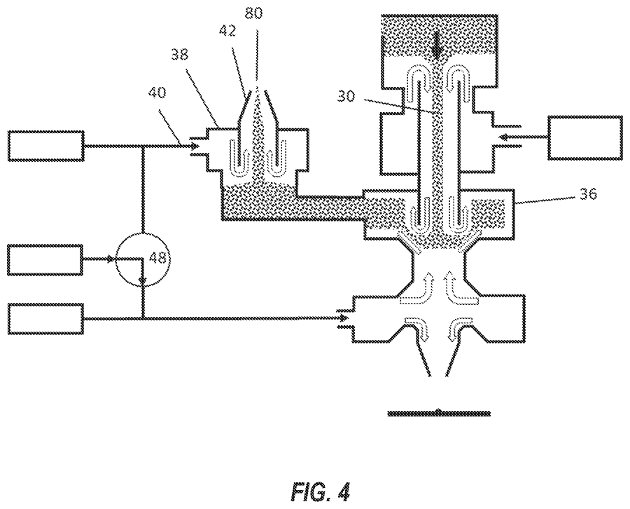

When valve 48 remains in the divert state, the steady divert state shown in FIG. 4 is achieved. In the divert state, aerosol 30 propagates through exhaust plenum 36, up to exhaust sheath plenum 38 where exhaust sheath flow 40 is added circumferentially to aerosol flow 30 and combined flow 80 is expelled through exhaust nozzle 42. Similar to the operation of the deposition nozzle, the addition of exhaust sheath flow 40 prevents aerosol flow 30 from contacting exhaust nozzle 42.

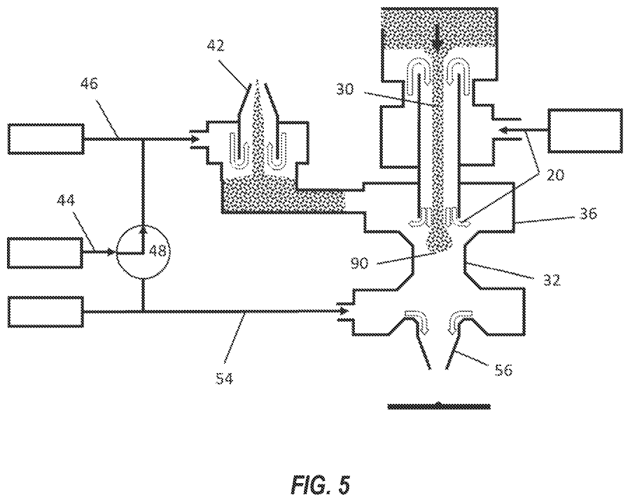

Resumption of deposition, shown in FIG. 5, is initiated by switching valve 48 to cause boost flow 44 to be combined with exhaust fill flow 46, thereby decreasing the flow out of exhaust plenum 36 by the amount of boost flow 44. All of the aerosol flow, plus a portion of master sheath flow 20, enters switching gallery 32. Nearly simultaneously, valve 48 actuation causes sheath boost flow 54 to be decreased by an amount equal to boost flow 44, which removes opposition to aerosol flow 30 through the switching gallery 32, and aerosol front 90 resumes propagation in the direction of deposition nozzle 56. Since the transport path preferably operates at approximately a constant pressure, exhaust nozzle 42 and deposition nozzle 56 have constant flow through them.

The pressure inside the transport path is a consequence of the flow generated by the mass flow controllers through the resistances presented by the nozzles. Since the mass flow controllers provide substantially constant flow and the nozzles provide substantially constant resistance at that flow, the pressure throughout remains substantially constant. Three-way valve 48 switches the boost flow entry point into the transport path, but the total inflow and the flow out through each of the nozzles remain substantially constant; the aerosol flow is simply switched from one nozzle to the other.

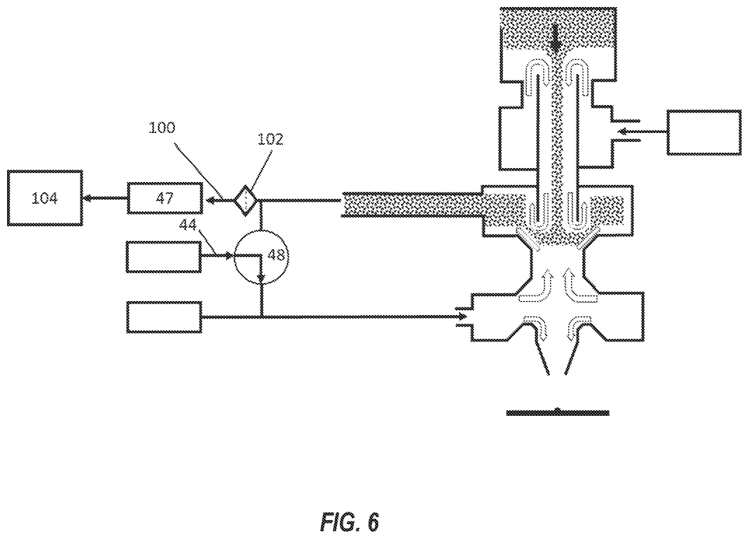

Although exhaust nozzle 42 is the preferred exhaust configuration because of its simplicity and reliability, an alternative configuration that generates a constant flow at the exhaust outlet is shown in FIG. 6. Vacuum pump 104 presents a negative pressure to exhaust fill mass flow controller 47 which extracts exhaust fill mass flow controller flow 100 preferably through filter 102. The flow through exhaust fill mass flow controller 47 remains substantially constant. While diverting, valve 48 prevents boost flow 44 from combining with exhaust fill mass flow controller flow 100, resulting in higher flow out of the exhaust plenum, supporting the diversion process. If valve 48 is switched to so that it augments exhaust fill mass flow controller flow 100 with supply boost flow 44, thereby reducing the flow out of the exhaust plenum by the amount of boost flow 44, the system is switched to the deposition process and deposition is initiated.

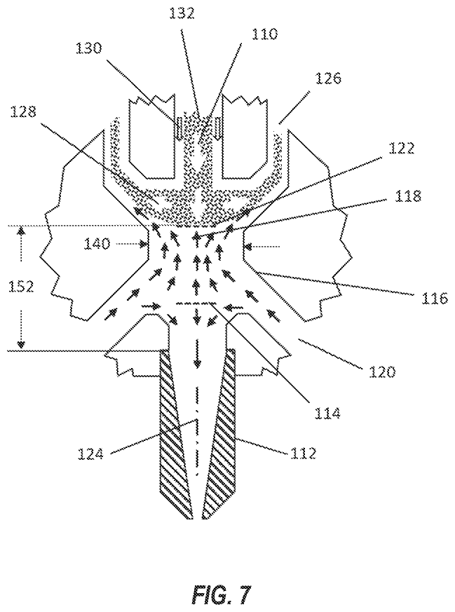

The flows through the switching gallery during diversion are shown in FIG. 7. While diverting, the movement of aerosol 132 in aerosol flow 110 in the direction of deposition nozzle 112 nozzle is stopped at a location near central axis 124 of switching gallery 116. The velocity of blocking flow 118 from sheath boost inlet 120 is preferably equal and opposite to aerosol flow 110, resulting in mist front stagnation plane 122, preferably perpendicular to central switching gallery axis 124. Aerosol flow 110 is suspended at this stagnation plane and is diverted radially outward to exhaust outlet 126. Radial aerosol flow 128 in the exhaust channel is sheathed by blocking flow 118 along the surface of switching gallery 116 that faces deposition nozzle 112 and sheathed by master sheath flow 130 on the opposite surfaces, preventing contact between both aerosol flow 110 and radial aerosol flow 128 and the inner walls of switching gallery 116, thus avoiding material build up and associated system failures. Concurrently, nozzle stagnation plane 114 is parallel to mist front stagnation plane 122 and positioned between mist front stagnation plane 122 and the entrance to deposition nozzle 112. The shape and size of switching gallery 116 and the magnitude of the flows entering and exiting the gallery determine the locations of and distance between mist front stagnation plane 122 and nozzle stagnation plane 114 and consequently defining how abruptly the propagation of the aerosol flow to the deposition nozzle is interrupted and resumed.

The rates of interruption and resumption of the aerosol flow are herein referred to as the fade in and out times respectively. Fade in and out times are minimally bounded by the speed at which the flow fields inside the switching gallery reconfigure to establish or eliminate stagnation plane 122 and nozzle stagnation plane 114 due to boost flow switching by valve 48. Simulation predicts that flow field reconfiguration occurs at much less than 1 ms, resulting in fade in and fade out times less than 1 ms given appropriate flow rates and the valve switching speed. Very low fade in and out times such as these enable switching rates of hundreds of hertz given appropriate valve switching speeds. Fast fade in and out times are very important in applications where printing sequences of dots or dashes at high speeds are desired. In these applications, the maximum print speed and the number of features that can be printed per second is directly limited by the fade in and fade out times. The print velocity must be constrained so that fading in or out does not create an indistinct or smeared edge to the feature. Fade in and out times are independent of how long it takes the modulated aerosol front to propagate through the rest of the transport path and out of the deposition nozzle. In contrast, delay times (on and off) include the fade times and the time necessary for the aerosol front to propagate through the deposition nozzle and impact on the substrate surface as well as valve switching times.

The switching gallery is preferably axisymmetric in shape and central switching gallery diameter 140 determines the velocity profile for a given flow rate. The velocity profile through the center of switching gallery 116 is inversely proportional to the square of its diameter. The time it takes from switching a flow to initiate deposition until the aerosol flow is completely on is herein referred to as the on delay, and the time it takes from switching a flow to divert the aerosol until no aerosol is exiting the nozzle is referred to as the off delay. When switching from the diversion state to the deposition state, the time taken for the aerosol flow 110 to traverse distance 152 from mist front stagnation plane 122 along central switching gallery axis 124 to the entrance of deposition nozzle 112 represents the majority of the on delay. Minimizing distance 152 enables minimization of the on delay. Minimizing distance 152 also minimizes the distance between the boost flow inlet and mist front stagnation plane 122, which is beneficial for minimal off delay. In one embodiment of the present invention, due to elimination of the mist tube separating the switching chamber from the boost flow chamber that was required in previous devices, distance 152 is 2.8 mm, corresponding to an on delay of less than about 6 ms, which is greater than an 80% reduction in length relative to previous internal pneumatic shutter designs and a commensurate reduction in on delay relative to the two designs. Fine feature printing of less than about 10 μm feature sizes in width typically require very low flow rates but still require high speed shuttering (diversion), with on and off delays <10 ms. Reducing switching gallery diameter 140 along with distance 152 supports <10 ms on and off times at flows needed for fine feature printing.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method for controlling deposition of an aerosol, the method comprising:
supplying an aerosol to a transport tube in a deposition apparatus;
surrounding the exterior of the transport tube with a transport sheath gas;
surrounding the aerosol with the transport sheath gas before the aerosol enters the transport tube;
transporting the aerosol and surrounding transport sheath gas to a switching chamber of the deposition apparatus;
exhausting a boost gas and an exhaust sheath gas from the deposition apparatus;
surrounding both the aerosol and the transport sheath gas with a deposition sheath flow to form a combined flow;
passing the combined flow through a deposition nozzle;
switching a flow path of the boost gas so it is added to the deposition sheath flow instead of being exhausted from the deposition apparatus, thereby stopping a flow of the aerosol into the deposition nozzle; and
exhausting the aerosol from the deposition apparatus.

2. The method of claim 1 wherein a pressure in the switching chamber remains approximately constant while performing the method.

3. The method of claim 1 wherein a gas flow rate through the deposition nozzle is approximately constant while performing the method.

4. The method of claim 1 wherein the aerosol is surrounded by at least one sheath gas until the step of exhausting the aerosol from the deposition apparatus, thereby preventing the aerosol from accumulating on surfaces of an aerosol transport path through the deposition apparatus.

5. The method of claim 1 wherein the step of exhausting the boost gas and the exhaust sheath gas from the deposition apparatus comprises passing the boost gas and the exhaust sheath gas through an exhaust nozzle.

6. The method of claim 5 wherein the step of exhausting the aerosol from the deposition apparatus comprises surrounding the aerosol with the exhaust sheath gas before the aerosol passes through the exhaust nozzle.

7. The method of claim 6 wherein a flow rate through the exhaust nozzle is approximately constant while performing the method.

8. The method of claim 1 wherein a time required to switch the aerosol from flowing toward the deposition nozzle to flowing toward an exhaust of the deposition apparatus is less than approximately 1 ms.

9. The method of claim 1 wherein a time required for a flow of aerosol to stop exiting the deposition nozzle after the switching step is less than approximately 10 ms.

10. The method of claim 1 further comprising:
switching back a flow path of the boost gas so it is exhausted from the deposition apparatus instead of being added to the deposition sheath flow, thereby starting a flow of the aerosol toward the deposition nozzle; and
passing the combined flow through the deposition nozzle.

11. The method of claim 10 wherein a time required to switch the aerosol from flowing toward an exhaust of the deposition apparatus to flowing toward the deposition nozzle is less than approximately 1 ms.

12. The method of claim 10 wherein a time required for a predetermined flow of aerosol to exit the deposition nozzle after the switching back step is less than approximately 10 ms.

13. The method of claim 1 further comprising dividing the transport sheath gas into an exhaust portion and a deposition portion after the transporting step so that the combined flow comprises the aerosol surrounded by the deposition portion, both being surrounded by the deposition sheath flow.

14. The method of claim 13 wherein the step of exhausting a boost gas and an exhaust sheath gas from the deposition apparatus comprises surrounding the exhaust portion with the boost gas and exhaust sheath gas and exhausting the exhaust portion, the boost gas, and the exhaust sheath gas from the deposition apparatus.
